(19) United States
(12) Patent Application Publication
(10) Pub. No.: US 2015/0328745 A1
(43) Pub. Date: Nov. 19, 2015

(54) MACHINE TOOL WITH SWIVELING TABLE

(71) Applicant: JTEKT CORPORATION, Osaka-shi (JP)

(72) Inventor: Akira MAKIUCHI, Anjo-shi (JP)

(73) Assignee: JTEKT CORPORATION, Osaka-shi (JP)

(21) Appl. No.: 14/709,610

(22) Filed: May 12, 2015

(30) Foreign Application Priority Data
May 19, 2014 (JP) 2014-103378

(51) Int. Cl. B24B 41/06; B23Q 3/02; B24B 5/307; B24B 5/16; B24B 5/26

(52) U.S. Cl. CPC B24B 41/061; B24B 5/16; B24B 5/26; B24B 5/307; B23Q 3/02

(57) ABSTRACT

A machine tool is provided in which chips and the like are prevented from adhering to a sliding surface of an upper surface of a base and a sliding surface of a lower surface of a swiveling table. A machine tool includes a base that has four corners and is shaped to be elongated, a swiveling table that swivels while sliding on an upper surface of the base, and a swiveling cover that is supported by the base or the swiveling table so as to be able to swivel. The swiveling cover protrudes from a widthwise edge of the swiveling table to cover a corner upper surface of the base in a first state where the swiveling table is not present on the corner upper surface, and is housed under the swiveling table in a second state where the swiveling table is present on the corner upper surface.

### INCORPORATION BY REFERENCE

The disclosure of Japanese Patent Application No. 2014-103378 filed on May 19, 2014 including the specification, drawings and abstract is incorporated herein by reference in its entirety.

### BACKGROUND OF THE INVENTION

1. Field of the Invention

The invention relates to a machine tool with a swiveling table.

2. Description of Related Art

Machine tools described in Japanese Patent Application Publication No. H11-77493 (JP H11-77493A) and Japanese Patent Application Publication No. H7-195266 (JP H7-195266 A) include a swiveling table that swivels while it slides on an upper surface of a base in order to perform taper machining in which a tapered portion is formed on a workpiece or taper correction. An actuator provided at a longitudinal first end of the swiveling table moves the position of the first end of the swiveling table with respect to the base to adjust the swiveling angle of the swiveling table with respect to the base.

When the swiveling table swivels, the upper surface of the base is exposed. Chips and the like adhering to a sliding surface of the upper surface of the base or a sliding surface of a lower surface of the swiveling table have an adverse effect on swiveling of the swiveling table. Therefore, it is required to remove chips and the like every time the swiveling table is to be swiveled.

### SUMMARY OF THE INVENTION

It is an object of the present invention to provide a machine tool with a swiveling table that prevents chips and the like from adhering to a sliding surface of an upper surface of a base and a sliding surface of a lower surface of the swiveling table.

According to an aspect of the present invention, a machine tool with a swiveling table includes:

a base that has four corners and is shaped to have a length larger than a width;

a swiveling table that is shaped to have a length larger than a width and that swivels while sliding on an upper surface of the base; and

a swiveling cover that is supported by the base or the swiveling table so as to be able to swivel, and protrudes from a widthwise edge of the swiveling table to cover a corner upper surface of the base in a first state where the swiveling table is not present on the corner upper surface of the base, and is housed under the swiveling table in a second state where the swiveling table is present on the corner upper surface of the base.

Since the swiveling cover is supported by the base or the swiveling table so as to be able to swivel, it is possible to realize the state where the swiveling cover protrudes from the widthwise edge and the state where the swiveling cover is housed under the swiveling table. In the first state where the swiveling table is not present on the corner upper surface of the base, the corner upper surface is not covered by the swiveling table. However, in the first state, the swiveling cover protrudes from the widthwise edge of the swiveling table to cover the corner upper surface. Thus, the corner upper surface is not exposed, and chips and the like are prevented from adhering to a sliding surface of the upper surface of the base.

Moreover, in the second state where the swiveling table is present on the corner upper surface of the base, the swiveling cover is housed under the swiveling table. Therefore, in the second state, the amount by which the swiveling cover protrudes from the widthwise edge of the swiveling table is reduced. In other words, in the second state, the presence of the swiveling cover prevents an increase in a distance from the operator to the widthwise edge of the swiveling table, and improves the efficiency of operation.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a plan view of a machine tool in the present embodiment;

FIG. 2 is a plan view of a swiveling table main body constituting the machine tool in FIG. 1;

FIG. 3 is a view of the swiveling table main body in FIG. 2 as viewed in the direction of arrow 3;

FIG. 4 is a cross-sectional view of the swiveling table main body in FIG. 2 taken along 4-4 in FIG. 2;

FIG. 5 is a cross-sectional view of the swiveling table main body in FIG. 2 taken along 5-5 in FIG. 2;

FIG. 6 is a plan view of a traverse table constituting the machine tool in FIG. 1;

FIG. 7 is a cross-sectional view of the traverse table in FIG. 6 taken along 7-7 in FIG. 6;

FIG. 8 is a plan view of the swiveling table constituting the machine tool in FIG. 1;

FIG. 9 is a cross-sectional view of the swiveling table in FIG. 8 taken along 9-9 in FIG. 8;

FIG. 10 is a plan view depicting a table unit and swiveling covers in a state where the swiveling table of the machine tool in FIG. 1 has swiveled;

FIG. 11 is a plan view depicting the external shape of the traverse table and swiveling table of the table unit in FIG. 10 and the external shape of the swiveling covers, in which hatched parts depict the swiveling covers;

FIG. 12 is a cross-sectional view taken along 12-12 in FIG. 10;

FIG. 13 is a plan view depicting the table unit and the swiveling covers in a case where the swiveling table of the machine tool in FIG. 1 is not swiveled;

FIG. 14 is a plan view depicting the external shape of the traverse table and swiveling table of the table unit in FIG. 13 and the external shape of the swiveling covers, in which hatched parts depict the swiveling covers; and

FIG. 15 is a cross-sectional view taken along 15-15 in FIG. 13.

### DETAILED DESCRIPTION OF EMBODIMENTS

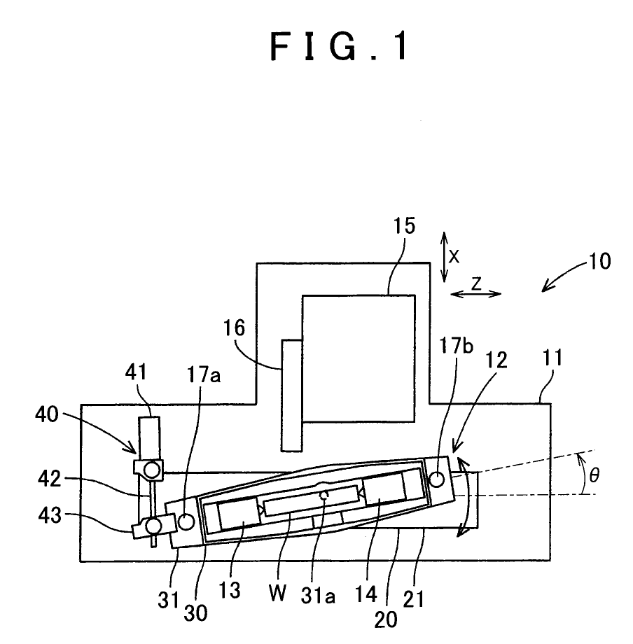

A machine tool in an embodiment of the present invention will be described with reference to the drawings. In the present embodiment, a table traverse grinding machine is taken as an example. As depicted in FIG. 1, the machine tool 10 includes a bed 11, an elongate table unit 12 that is movable on an upper surface of the bed 11 in a Z axis direction, a spindle head 13 and a tailstock 14 fixed on the upper surface of the table unit to support an elongate workpiece W at opposite ends thereof, a wheel spindle stock 15 that is movable on the bed 11 in an X axis direction, and a grinding wheel 16 rotatably supported by the wheel spindle stock 15.

The table unit 12 includes a traverse table 20 (corresponding to a base in the present invention) that is movable on the upper surface of the bed in the Z axis direction, a swiveling table 30 provided on an upper surface of the traverse table 20 so as to be able to swivel, and an actuator 40 that adjusts the swiveling angle θ of the swiveling table 30 with respect to the traverse table 20.

The traverse table 20 includes a traverse table main body 21 and fixing covers 22 and 23 for the traverse table. However, in FIG. 1, only the traverse table main body 21 is illustrated, and the fixing covers 22 and 23 for the traverse table are not illustrated. Furthermore, similarly, the swiveling table 30 includes a swiveling table main body 31 and fixing covers 32 and 33 for the swiveling table. However, in FIG. 1, only the swiveling table main body 31 is illustrated, and the fixing covers 32 and 33 for the swiveling table are not illustrated. The fixing covers 22 and 23 for the traverse table and the fixing covers 32 and 33 for the swiveling table will be described below.

The traverse table main body 21 is shaped like an elongate rectangle. The traverse table main body 21 is driven by the actuator so as to be movable on the bed 11 in the Z axis direction. An upper surface of the traverse table main body 21 is, for example, scraped so as to enable a lower surface of the swiveling table main body 31 to slide on the upper surface.

The swiveling table main body 31 is shaped to be elongate and supported on the upper surface of the traverse table main body 21 so as to be able to swivel. Specifically, the swiveling table main body 31 swivels around a swiveling center 31a while sliding on the upper surface of the traverse table main body 21. FIG. 1 illustrates a state in which the swiveling table main body 31 has swiveled by the swiveling angle θ with respect to the traverse table main body 21. The lower surface of the swiveling table main body 31 is, for example, scraped like the upper surface of the traverse table main body 21.

The actuator 40 adjusts the swiveling angle θ of the swiveling table 30 with respect to the traverse table 20. The actuator 40 is provided at a first end of longitudinal ends of the swiveling table 30 to move the position of the first end of the swiveling table 30 relative to the traverse table 20. The actuator 40 is provided at a first end of longitudinal ends of the traverse table main body 21, and the first end is located on the same side as the first end of the swiveling table 30. More specifically, the actuator 40 includes a motor 41, a ball screw 42 coupled to the motor 41, and a ball screw nut 43 provided on one end side of the swiveling table main body 31. The motor 41 drives the ball screw 42, and the ball screw 42 rotates to move the position of the ball screw nut 43 on an X-Z plane to swivel the swiveling table 30 to which the ball screw nut 43 is attached.

Moreover, the machine tool 10 includes clamp apparatuses 17a and 17b that allow the swiveling table 30 to be fixed to the traverse table 20 when the swiveling table 30 has swiveled with respect to the traverse table 20. The clamp apparatuses 17a and 17b are provided at opposite ends of the swiveling table main body 31 in a longitudinal direction.

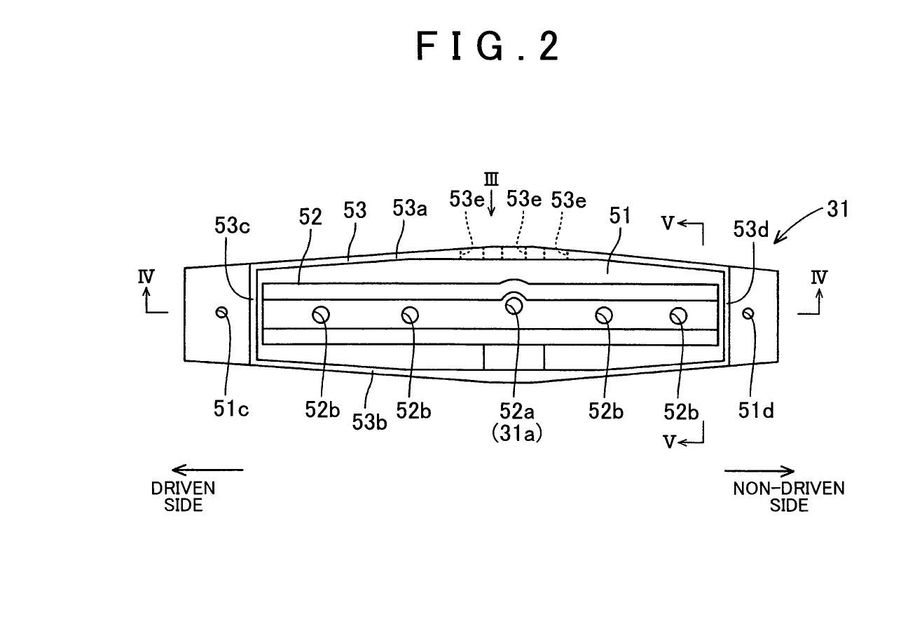

A detailed configuration of the swiveling table main body 31 will be described with reference to FIGS. 2 to 5. In FIG. 2, a left side is a driven side (corresponding to a longitudinal first end in the present invention) driven by the actuator 40, and a right side is a non-driven side (corresponding to a longitudinal second end in the present invention). The longitudinally opposite ends of the swiveling table main body 31 are hereinafter referred to as a driven side end and a non-driven side end.

The external shape of the swiveling table main body 31 is such that longitudinally opposite vertices of a rhombus are chamfered as depicted in FIG. 2. The external shape of the swiveling table main body 31 is formed such that, in the longitudinal direction of the swiveling table main body, the width of the swiveling table main body 31 increases from each of the driven side end and the non-driven side end toward the swiveling center 31a. In other words, in the longitudinal direction, the swiveling table main body 31 is widest near the swiveling center 31a. A width direction of the swiveling table main body 31 is a direction orthogonal to the longitudinal direction as viewed from an upper surface of the swiveling table main body 31. The width of the swiveling table main body 31 is different from the vertical thickness of the swiveling table main body 31. Furthermore, a width direction of the swiveling table 30, a width direction of the traverse table 20, and a width direction of the traverse table main body 21 have a meaning similar to the meaning of the width direction of the swiveling table main body 31.

More specifically, the shape of the swiveling table main body 31 from the swiveling center 31a to the driven side end is formed like an isosceles trapezoid. The shape of the swiveling table main body 31 from the swiveling center 31a to the non-driven side end is formed like an isosceles trapezoid.

Since the swiveling table main body 31 is shaped as described above, rigidity against a bending force exerted in a swiveling plane (X-Z plane) of the swiveling table main body 31, in other words, the bending force that acts to bend the swiveling table main body 31 in the X-Z plane, is set to increase from the driven side end of the swiveling table main body 31 toward the swiveling center 31a. Furthermore, the rigidity of the swiveling table main body 31 is set to increase from the non-driven side end of the swiveling table main body 31 toward the swiveling center 31a.

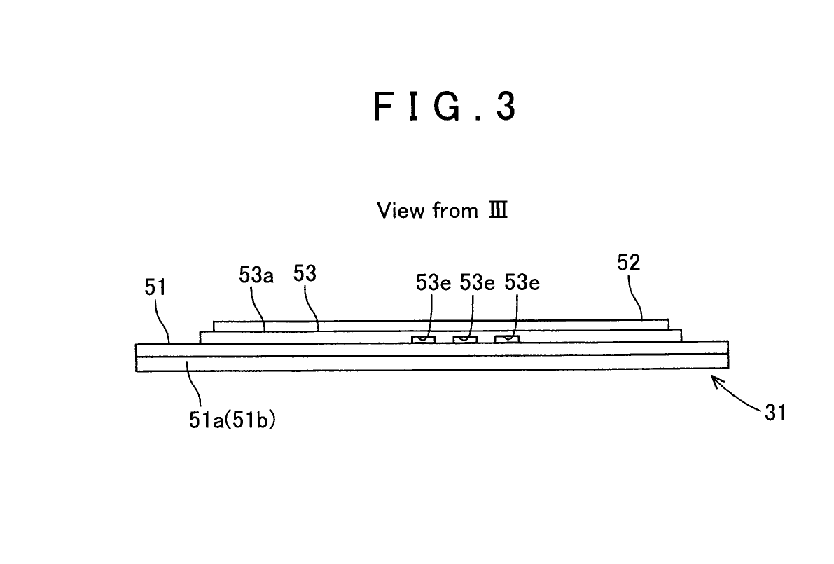

Furthermore, the swiveling table main body 31 includes a base 51 that slides on the upper surface of the traverse table main body 21 and that defines the external shape of the swiveling table main body 31, a mounting table 52 provided near the center of the upper surface of the base 51, and a rib 53 erected at the periphery of the upper surface of the base 51. As depicted in FIG. 3 and FIG. 5, cutouts 51a and 51b are formed in a lower side of the base 51 along the widthwise opposite edges of the swiveling table main body 31. Holes 51c and 51d penetrated by components of the clamp apparatuses 17a and 17b are formed at longitudinally opposite ends of the base 51.

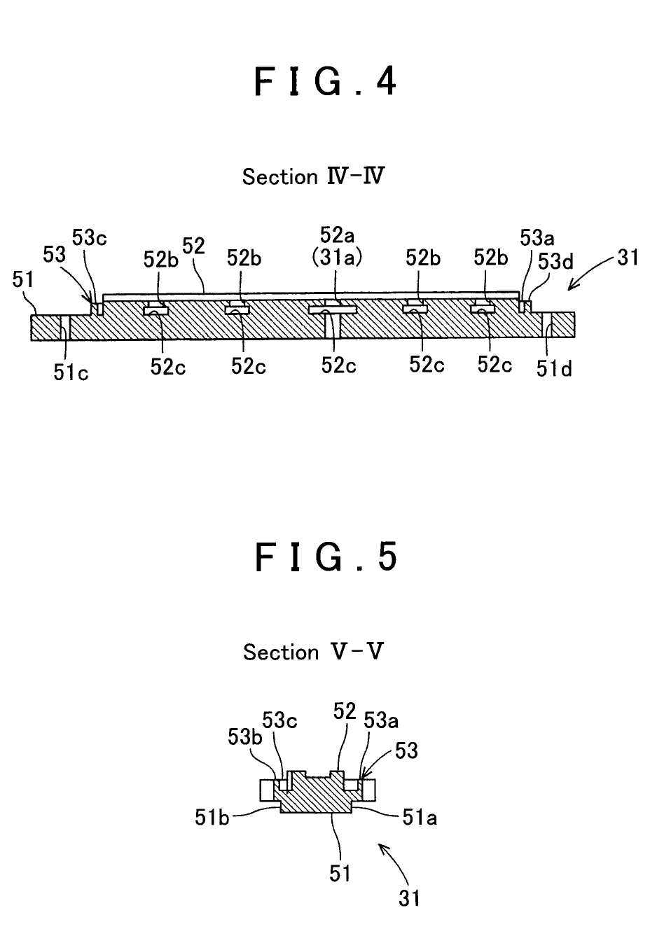

The mounting table 52 is shaped to be elongate and provided near the center of the upper surface of the base 51 so as to protrude upward (FIGS. 2 and 3). The spindle head 13 and the tailstock 14 are mounted on an upper surface of the mounting table 52. As depicted in FIG. 2 and FIG. 4, a central hole 52a penetrating the swiveling table main body 31 is formed in the center of the mounting table 52 and the base 51. The center of the central hole 52a coincides with the swiveling center 31a. Moreover, a plurality of vertical holes 52b and a plurality of horizontal holes 52c forming coolant channels are formed in the mounting table 52. The vertical holes 52b are formed on the upper surface of the base 51 such that two holes are arranged at a distance from each other on each of the driven and non-driven side ends with respect to the central hole 52a. As depicted in FIG. 4, the horizontal holes 52c are formed on an upper side of a virtual plane including the upper surface of the base 51 so as to penetrate the mounting table 52 in the widthwise direction of the swiveling table main body 31. The respective horizontal holes 52c are in communication with the central hole 52a and the vertical holes 52b. Therefore, a coolant falling onto the upper surface of the mounting table 52 flows through the vertical holes 52b and the horizontal holes 52c to the upper surface of the base 51.

As depicted in FIG. 2 and FIG. 4, the rib 53 is erected all over the periphery of the swiveling table main body 31 at a distance from the outer periphery of the mounting table 52. In other words, the rib 53 includes long side ribs 53a and 53b erected along widthwise opposite ends of the swiveling table main body 31 and short side ribs 53c and 53d that connect ends of the long side ribs 53a to respective ends of the long side ribs 53b.

The thickness of each of the long side ribs 53a and 53b is set to increase from the driven side end and the non-driven side end toward the swiveling center 31a. In other words, the thickness of each of the long side ribs 53a and 53b (the widthwise thickness of the swiveling table main body 31) is largest near the swiveling center 31a. Since the long side ribs 53a and 53b are shaped as described above, the rigidity against the bending force exerted in the swiveling plane (X-Z plane) of the swiveling table main body 31, in other words, the bending force that acts to bend the swiveling table main body 31 in the X-Z plane, is set to increase from the driven side end of the swiveling table main body 31 toward the swiveling center 31a. Furthermore, the rigidity of the swiveling table main body 31 is set to increase from the non-driven side end of the swiveling table main body 31 toward the swiveling center 31a.

As depicted in FIG. 3, through-holes 53e are formed through which the coolant flows from the mounting table 52 side toward the outside of the long side rib 53a. As described above, the coolant having fallen onto the upper surface of the mounting table 52 flows via the vertical holes 52b, the horizontal holes 52c, and the like or directly through an outer peripheral edge of the mounting table 52, to an area of the upper surface of the base 51 that is enclosed by the rib 53. The coolant flows onto the outside of the swiveling table main body 31, that is, onto the bed 11, via the through-holes 53e formed in the long side rib 53a.

In this regard, the through-holes 53e formed in the long side rib 53a are formed near the swiveling center 31a. Thus, even with a change in the swiveling angle θ of the swiveling table main body 31, the position onto which the coolant falls through the through-holes 53e does not significantly change.

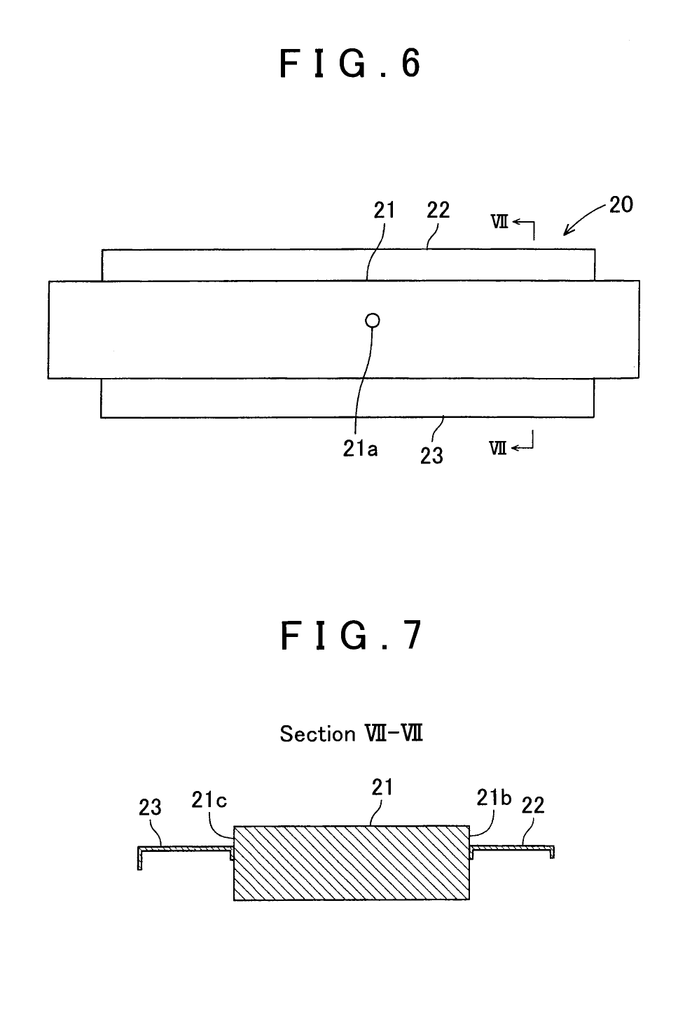

The traverse table 20 will be described with reference to FIG. 6 and FIG. 7. As depicted in FIG. 6 and FIG. 7, the traverse table 20 includes the traverse table main body 21 and the two fixing covers 22 and 23 for the traverse table. The traverse table main body 21 is shaped like a rectangle as described above. A recess 21a is formed near the center of the traverse table main body 21, and the center of the recess 21a coincides with the swiveling center 31a of the swiveling table main body 31. A shaft portion supporting the swiveling table main body 31 so that the swiveling table main body 31 can swivel is inserted into the recess 21a.

The two fixing covers 22 and 23 for the traverse table are shaped like rectangles and provided on respective widthwise opposite side surfaces 21b and 21c of the traverse table main body 21 so as to protrude outward in the width direction. As depicted in FIG. 7, the two fixing covers 22 and 23 are fixed near the center of the traverse table main body 21 in a height direction thereof. In the present embodiment, the fixing covers 22 and 23 for the traverse table are formed separately from the traverse table main body 21 but may be integrally formed.

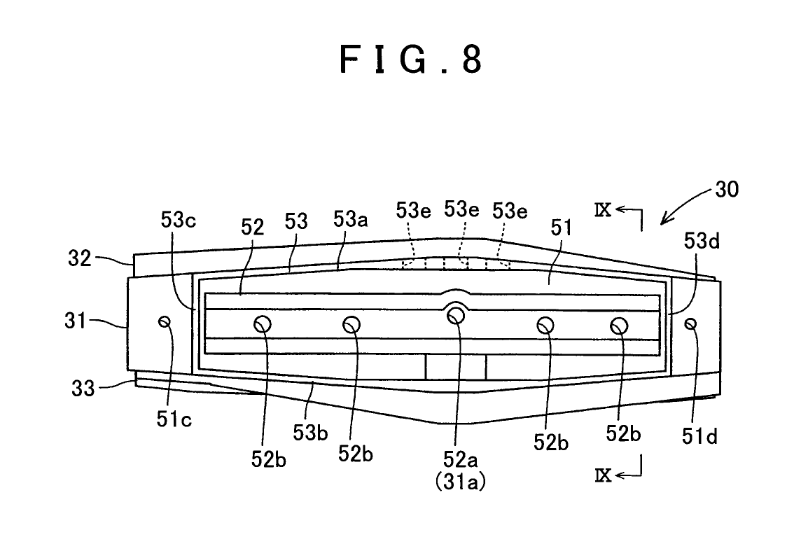

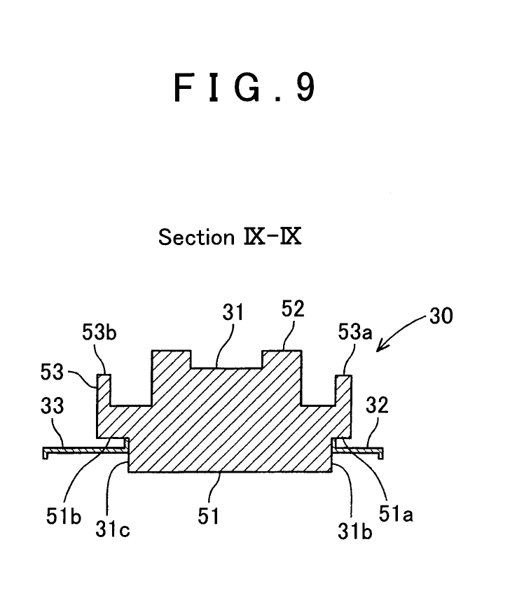

The swiveling table 30 will be described with reference to FIG. 8 and FIG. 9. As depicted in FIG. 8 and FIG. 9, the swiveling table 30 includes the swiveling table main body 31 and the two fixing covers 32 and 33 for the swiveling table. The two fixing covers 32 and 33 are provided on respective widthwise opposite side surfaces of the swiveling table main body 31 so as to protrude outward in the width direction. The two fixing covers 32 and 33 are shaped along the widthwise side surfaces of the swiveling table main body 31, that is, shaped to be bent near the center. Furthermore, the widths of the two fixing covers 32 and 33 are formed to be substantially equal along the longitudinal direction.

In other words, the external shape of the swiveling table 30 with the fixing covers 32 and 33 is generally such that longitudinally opposite vertices of a rhombus are chamfered similarly to the external shape of the swiveling table main body 31. The width of the swiveling table 30 is set to increase from each of the driven and non-driven side ends toward the swiveling center 31a. In other words, the swiveling table 30 is widest near the swiveling center 31a in the longitudinal direction. More specifically, an area of the swiveling table 30 from the swiveling center 31a to the driven side end is shaped like an isosceles trapezoid. An area of the swiveling table 30 from the swiveling center 31a to the non-driven side end is also shaped like an isosceles trapezoid.

Accordingly, since the swiveling table 30 is shaped as described above, the rigidity against the bending force exerted in the swiveling plane (X-Z plane) of the swiveling table main body 31, in other words, the bending force that acts to bend the swiveling table main body 31 in the X-Z plane, is set to increase from the driven side end of the swiveling table main body 31 toward the swiveling center 31a. Furthermore, the rigidity of the swiveling table 30 is set to increase from the non-driven side end of the swiveling table 30 toward the swiveling center 31a.

In the present embodiment, the fixing covers 32 and 33 for the swiveling table are formed separately from the swiveling table main body 31 but may be formed integrally with the swiveling table main body 31. In this case as well, the rigidity has a relation similar to the above-described relation.

The external shape of the swiveling table 30 formed as described above allows the swiveling table 30 to produce the following effects. The driven side end of the swiveling table 30 directly receives a moving force exerted by the actuator 40 and thus moves to the desired position. However, a position to which the moving force is applied is away from the swiveling center 31a, and thus, the swiveling table 30 is deflected. Thus, the swiveling angle is not equal to a desired angle at a certain point of the swiveling table 30.

However, as described above, the rigidity against the bending force exerted in the swiveling plane of the swiveling table 30 is set to increase from the driven side end of the swiveling table 30 toward the swiveling center 31a. Since the rigidity of the swiveling table 30 is high near the swiveling center 31a, the vicinity of the swiveling center 31a of the swiveling table 30 reliably swivels. Therefore, the amount of deflection of the swiveling table 30 is reduced.

In particular, since the width of the swiveling table 30 is set to increase from the driven side end toward the swiveling center 31a, the rigidity of the swiveling table 30 reliably increases from the driven side end toward the swiveling center. Consequently, the amount of deflection of the swiveling table 30 is reliably reduced.

In this regard, an increased swiveling angle of the swiveling table 30 increases the amount by which a corner of the swiveling table 30 protrudes from the traverse table 20. The amount by which the corner of the swiveling table 30 protrudes from the traverse table 20 corresponds to the length of a portion of the corner of the swiveling table 30 projects from a widthwise edge of the traverse table 20 (the length of the projecting portion in the width direction of the traverse table 20) as viewed from the upper surfaces of the swiveling table 30 and the traverse table 20.

For efficient operation by an operator, the amount by which the corner of the swiveling table 30 protrudes from the traverse table 20 is desirably reduced even with a large swiveling angle. When the width of the swiveling table 30 is set to increase from the driven side end toward the swiveling center 31a, the driven side end of the swiveling table 30 can be reduced in width. Therefore, the amount by which the corner of the swiveling table 30 protrudes from the traverse table 20 is reduced, improving the efficiency of operation by the operator. In particular, the area of the swiveling table 30 from the swiveling center 31a to the driven side end is shaped like an isosceles trapezoid. In this case, the amount by which the corner of the swiveling table 30 protrudes from the traverse table 20 is further reduced, further improving the efficiency of operation by the operator.

Furthermore, the rigidity against the bending force exerted in the swiveling plane of the swiveling table 30 is set to increase from the non-driven side end of the swiveling table 30 toward the swiveling center 31a. The area of the swiveling table 30 from the swiveling center 31a to the non-driven side end moves in conjunction with swiveling of the driven side end. The non-driven side end of the swiveling table 30, however, is not easily moved due to a frictional force exerted between the swiveling table 30 and the upper surface of the traverse table 20. In other words, the swiveling table 30 acts to deform so as to bend near the swiveling center 31a. Since the rigidity of the swiveling table 30 is high near the swiveling center 31a of the swiveling table 30, the non-driven side end of the swiveling table 30 reliably swivels. In other words, the swiveling table 30 can be restrained from being bent near the swiveling center 31a.

In particular, since the width of the swiveling table 30 is set to increase from the non-driven side end toward the swiveling center 31a, the rigidity of the swiveling table 30 reliably increases from the non-driven side end toward the swiveling center 31a. Consequently, the swiveling table 30 can be restrained from being bent near the swiveling center 31a. Moreover, the non-driven side end of the swiveling table 30 can be reduced in width. Therefore, the amount by which the corner of the swiveling table 30 protrudes from the traverse table 20 is reduced, improving the efficiency of operation by the operator. In particular, the area of the swiveling table 30 from the swiveling center 31a to the non-driven side end is shaped like an isosceles trapezoid. In this case, the amount by which the corner of the swiveling table 30 protrudes from the traverse table 20 is reduced, further improving the efficiency of operation by the operator.

Since the swiveling table main body 31 includes the above-described rib 53, the swiveling table 30 produces the following effects. Since the thickness of each of the long side ribs 53a and 53b is set to increase from the longitudinal driven side end toward the swiveling center 31a, the rigidity against the bending force exerted in the swiveling plane of the swiveling table 30 is set to increase from the longitudinal driven side end of the swiveling table 30 toward the swiveling center 31a. Consequently, the amount of deflection of the swiveling table 30 is reliably reduced.

Furthermore, since the thickness of each of the long side ribs 53a and 53b is set to increase from the longitudinal non-driven side end toward the swiveling center 31a, the rigidity of the swiveling table 30 is set to increase from the longitudinal non-driven side end of the swiveling table 30 toward the swiveling center 31a. Thus, the swiveling table 30 is restrained from being bent near the swiveling center 31a.

In particular, since the long side ribs 53a and 53b are provided on the widthwise opposite sides of the swiveling table main body 31, the rigidity of the swiveling table 30 reliably increases from longitudinally opposite ends toward the swiveling center 31a.

Furthermore, the through-holes 53e through which the coolant flows are formed in the long side rib 53a and 53b. Thus, a decrease in the rigidity of the swiveling table 30 can be suppressed, and at the same time, an outflow path is secured through which the coolant having flown to the upper surface of the base 51 flows out of the swiveling table.

As depicted in FIG. 1, a position where the swiveling table 30 covers the upper surface of the traverse table 20 changes according to the swiveling angle of the swiveling table 30 with respect to the traverse table 20. In particular, depending on the swiveling angle of the swiveling table 30, a part of a sliding surface formed on the upper surface of the traverse table main body 21 constituting the traverse table 20 may be exposed. Furthermore, depending on the swiveling angle of the swiveling table 30, a part of the swiveling table main body 31 protrudes from a widthwise edge of the traverse table main body 21. At this time, a part of a sliding surface formed on the lower surface of the swiveling table main body 31 may be exposed. The machine tool 10 further includes four swiveling covers 61 to 64 so as to avoid exposing the sliding surfaces of the traverse table main body 21 and the swiveling table main body 31 even when the swiveling table 30 swivels.

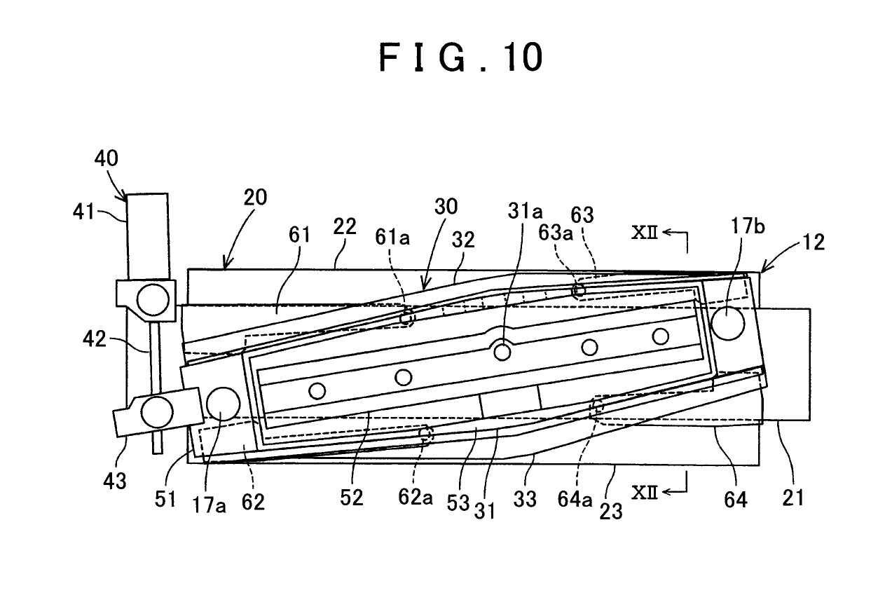

In other words, when the swiveling table 30 swivels with respect to the traverse table 20, the four swiveling covers 61 to 64 cover portions of the traverse table main body 21 and the swiveling table main body 31 that fail to be covered by the swiveling table main body 31 and the traverse table main body 21, respectively. The four swiveling covers 61 to 64 will be described with reference to FIGS. 10 to 12.

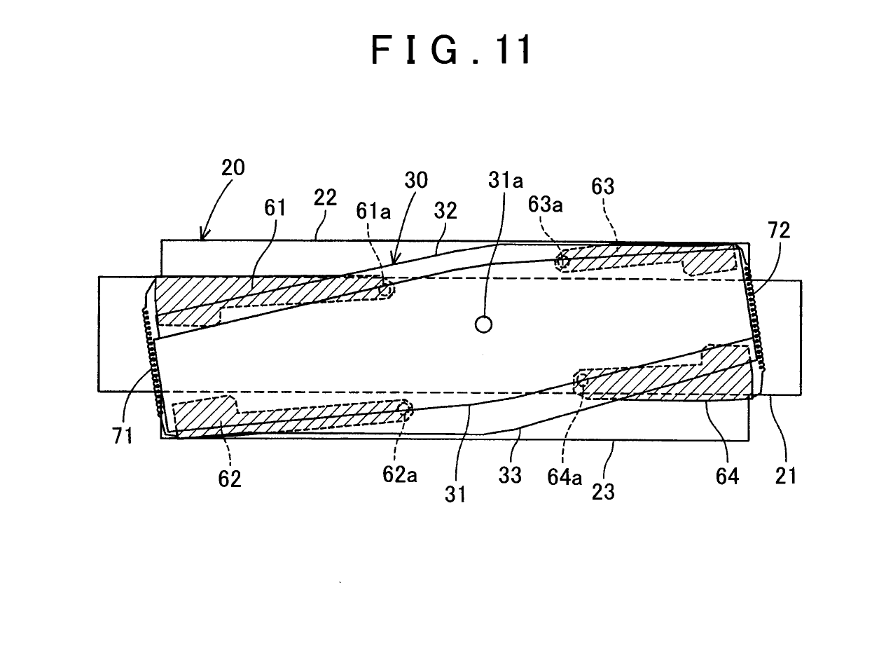

As depicted in FIG. 10 and FIG. 11, the four swiveling covers 61 to 64 are arranged at positions corresponding to respective four corners of the traverse table main body 21. In this case, the four corners of the traverse table main body 21 mean corners of the area forming the sliding surface of the traverse table main body 21.

The four swiveling covers 61 to 64 are supported near respective widthwise opposite edges of the swiveling table 30 so as to be able to swivel. Specifically, the four swiveling covers 61 to 64 are supported so as to be able to swivel with respect to the fixing covers 22 and 23 for the traverse table. In the present embodiment, the swiveling centers of the four swiveling covers 61 to 64 are set at different positions.

The first swiveling cover 61 is provided at one of the longitudinal driven side end (left side in FIG. 10) corners of the traverse table 20 that is closer to the wheel spindle stock 15 depicted in FIG. 1 (upper side in FIG. 10). A swiveling center 61a of the first swiveling cover 61 is present near a wheel spindle stock 15-side edge of the swiveling table 30 and is positioned near the swiveling center 31a of the swiveling table 30. The first swiveling cover 61 is provided so as to extend from the swiveling center 61a of the first swiveling cover 61 toward the driven side end of the swiveling table 30.

The second swiveling cover 62 is provided at one of the longitudinal driven side end (left side in FIG. 10) corners of the traverse table 20 that is across the first swiveling cover 61 from the wheel spindle stock 15 (lower side in FIG. 10). A swiveling center 62a of the second swiveling cover 62 is present near an edge of the swiveling table 30 and is across the swiveling center 61a from the wheel spindle stock 15 and is positioned near the swiveling center 31a of the swiveling table 30. The second swiveling cover 62 is provided so as to extend from the swiveling center 62a of the second swiveling cover 62 toward the driven side end of the swiveling table 30.

The third swiveling cover 63 is provided at one of the longitudinal non-driven side end (right side in FIG. 10) corners of the traverse table 20 that is closer to the wheel spindle stock 15 (upper side in FIG. 10). A swiveling center 63a of the third swiveling cover 63 is present near the wheel spindle stock 15-side edge of the swiveling table 30 and is positioned near the swiveling center 31a of the swiveling table 30. The third swiveling cover 63 is provided so as to extend from the swiveling center 63a of the third swiveling cover 63 toward the non-driven side end of the swiveling table 30.

The fourth swiveling cover 64 is provided at one of the longitudinal non-driven side end (right side in FIG. 10) corners of the traverse table 20 that is across the third swiveling cover 63 from the wheel spindle stock 15 (lower side in FIG. 10). A swiveling center 64a of the fourth swiveling cover 64 is present near the edge of the swiveling table 30 and is across the swiveling center 63a from the wheel spindle stock 15 and is positioned near the swiveling center 31a of the swiveling table 30. The fourth swiveling cover 64 is provided so as to extend from the swiveling center 64a of the fourth swiveling cover 64 toward the driven side end of the swiveling table 30.

Furthermore, the four swiveling covers 61 to 64 are supported by the swiveling table 30 so as to be able to swivel, which allows realizing a state where the swiveling cover protrudes from the widthwise edge of the swiveling table 30 and a state where the swiveling cover is housed under the swiveling table 30. The swiveling covers 61 to 64 in a swiveled state and in a non-swiveled state will be described in detail.

A state where the swiveling table 30 has swiveled with respect to the traverse table 20 (hereinafter referred to as the “swiveled state”) will be described with reference to FIGS. 10 to 12. In the swiveled state, the swiveling table main body 31 is not present on an upper left corner, in FIGS. 10 and 11, of the sliding surface of the upper surface of the traverse table main body 21. This state corresponds to a first state in the present invention. At this time, at the upper left corner, the first swiveling cover 61 protrudes from the widthwise edge of the swiveling table 30. Specifically, the first swiveling cover 61 protrudes from the corresponding edge of the fixing cover 32 for the swiveling table. Therefore, the first swiveling cover 61 covers an upper surface of the corner of the traverse table main body 21. Thus, the sliding surface of the upper surface of the corner of the traverse table main body 21 is not exposed, and chips and the like are prevented from adhering to the sliding surface.

Furthermore, in the swiveled state, the swiveling table main body 31 is not present on a lower right corner, in FIGS. 10 and 11, of the sliding surface of the upper surface of the traverse table main body 21 (first state). At this time, at the lower right corner, the fourth swiveling cover 64 protrudes from the widthwise edge of the swiveling table 30 to cover an upper surface of the corner of the traverse table main body 21.

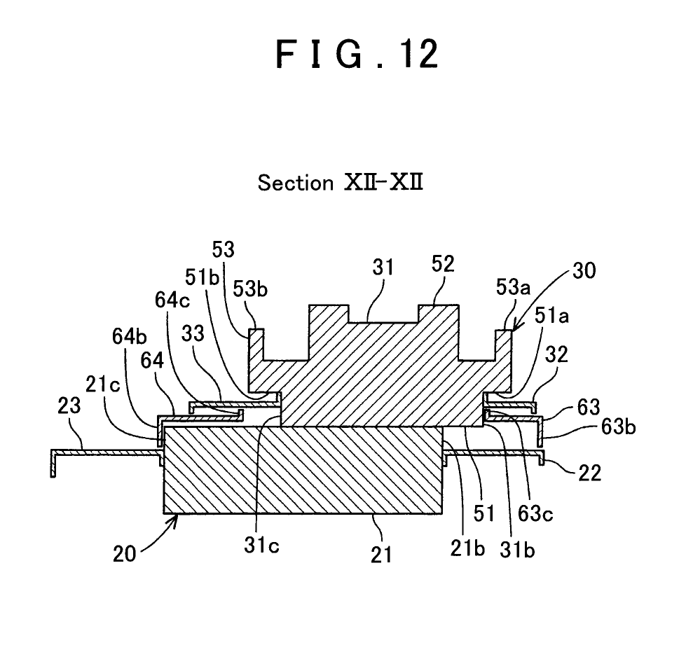

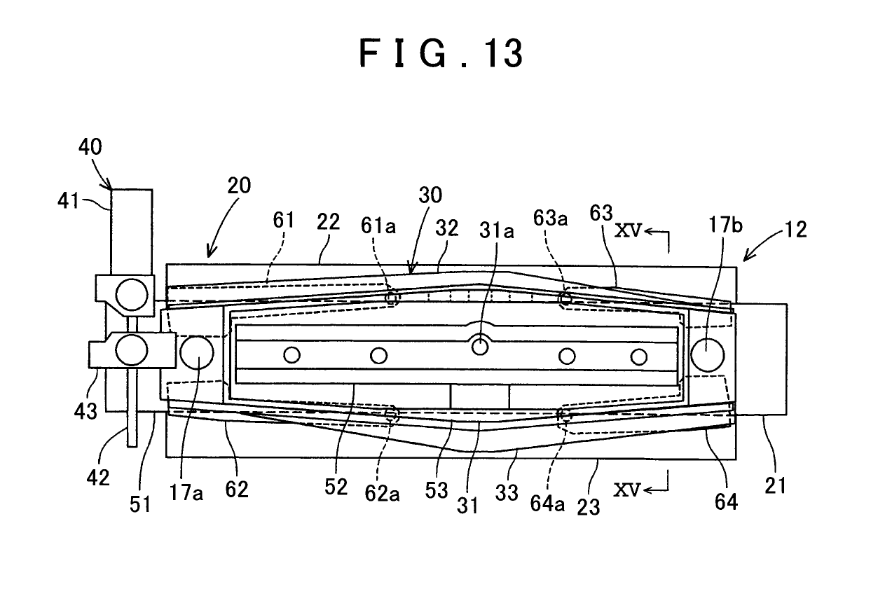

An outer regulating portion 64b (corresponding to a base regulating portion in the present invention) of the fourth swiveling cover 64 is bent downward as depicted in FIG. 12. The outer regulating portion 64b of the fourth swiveling cover 64 stops on a widthwise side surface 21c (corresponding to a base stopper portion) of the traverse table main body 21 (stops in contact with the widthwise side surface 21c) to keep the fourth swiveling cover 64 protruding from the widthwise edge of the swiveling table 30. The first swiveling cover 61 is similar to the fourth swiveling cover 64. Furthermore, the second swiveling cover 62 and the third swiveling cover 63 also include an outer regulating portion 63b (depicted in FIG. 12).

Additionally, in the swiveled state, the swiveling table main body 31 is present on a lower left corner of the sliding surface of the upper surface of the traverse table main body 21 as depicted in FIG. 10 and FIG. 11. This state corresponds to a second state in the present invention. At this time, at the lower left corner, most of the second swiveling cover 62 is housed under the swiveling table 30. Therefore, the amount by which the second swiveling cover 62 protrudes from the widthwise edge of the swiveling table 30 is reduced. The amount by which the second swiveling cover 62 protrudes from the widthwise edge of the swiveling table 30 corresponds to the length of a portion of the second swiveling cover 62 that projects from the widthwise edge of the swiveling table 30 (the length in the width direction of the swiveling table 30) as viewed from the upper surface of the swiveling table 30. In other words, in the second state, the second swiveling cover 62 is restrained from protruding. This prevents an increase in the distance from the operator to the widthwise edge of the swiveling table 30, and improves the efficiency of operation.

Furthermore, in the swiveled state, the swiveling table main body 31 is present on an upper right corner of the sliding surface of the upper surface of the traverse table main body 21 as depicted in FIG. 10 and FIG. 11 (second state). At this time, at the upper right corner, most of the third swiveling cover 63 is housed under the swiveling table 30. Therefore, the amount by which the third swiveling cover 63 protrudes from the widthwise edge of the swiveling table 30 is reduced.

An inner regulating portion 63c (corresponding to a table regulating portion in the present invention) of the third swiveling cover 63 is bent upward as depicted in FIG. 12. The inner regulating portion 63c of the third swiveling cover 63 stops in contact with a side surface 31b (corresponding to a table stopper portion) of the swiveling table main body 31 to regulate the amount by which the third swiveling cover 63 is housed under the swiveling table 30. The side surface 31b of the swiveling table main body 31 is a side surface of a cutout 51a in the swiveling table main body 31. Consequently, in the swiveled state, the third swiveling cover 63 keeps covering the sliding surface of the lower surface of the swiveling table main body 31. Therefore, chips and the like are reliably prevented from adhering to the sliding surface of the lower surface of the swiveling table main body 31. The second swiveling cover 62 has operations and effects similar to the operations and effects of the third swiveling cover 63. Furthermore, the first swiveling cover 61 and the fourth swiveling cover 64 also include an inner regulating portion 64c (depicted in FIG. 12).

The machine tool 10 further includes a first elastic member 71 and a second elastic member 72 as depicted in FIG. 11. The first elastic member 71 and the second elastic member 72 are, for example, coil springs formed to be stretchable in the longitudinal direction. The first elastic member 71 couples the first swiveling cover 61 and the second swiveling cover 62. The first elastic member 71 couples one of the ends of the first swiveling cover 61 that is opposite to the swiveling center to one of the ends of the second swiveling cover 62 that is opposite to the swiveling center. Similarly, the second elastic member 72 couples one of the ends of the third swiveling cover 63 that is opposite to the swiveling center to one of the ends of the fourth swiveling cover 64 that is opposite to the swiveling center.

In other words, the first elastic member 71 exerts a tensile force on the first swiveling cover 61 and the second swiveling cover 62 in a direction in which the first swiveling cover 61 and the second swiveling cover 62 approach each other. Therefore, in the swiveled state, the first elastic member 71 exerts the tensile force so as to reduce as much as possible the amount by which the first swiveling cover 61 and the second swiveling cover 62 project from the widthwise edges of the swiveling table 30. Specifically, the first elastic member 71 restricts movement of the first swiveling cover 61 away from the side surface 21c of the traverse table main body 21. Furthermore, the first elastic member 71 acts to increase the amount by which the second swiveling cover 62 is housed under the swiveling table 30.

The second elastic member 72 exerts a tensile force on the third swiveling cover 63 and the fourth swiveling cover 64 in a direction in which the third swiveling cover 63 and the fourth swiveling cover 64 approach each other. Therefore, in the swiveled state, the second elastic member 72 exerts the tensile force so as to reduce as much as possible the amount by which the third swiveling cover 63 and the fourth swiveling cover 64 project from the widthwise edges of the swiveling table 30. Specifically, the second elastic member 72 acts to increase the amount by which the third swiveling cover 63 is housed under the swiveling table 30. The second elastic member 72 restricts movement of the fourth swiveling cover 64 away from the side surface 21c of the traverse table main body 21. Accordingly, the first elastic member 71 and the second elastic member 72 improve the efficiency of operation by the operator.

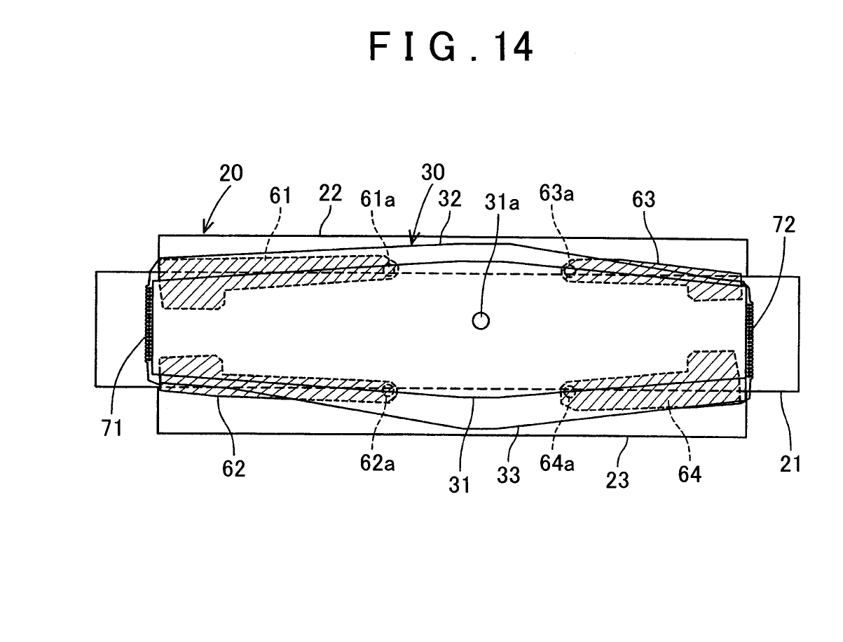

A state where the swiveling table 30 is not swiveled with respect to the traverse table 20 (hereinafter referred to as the non-swiveled state) will be described with reference to FIGS. 13 to 15. In the non-swiveled state, the swiveling table 30 is present on the four corners of the traverse table 20 (this corresponds to a second state in the present invention).

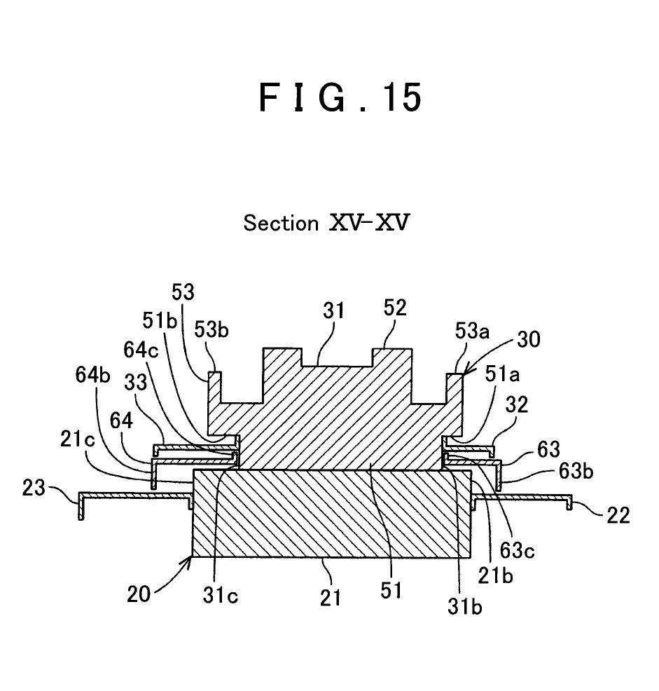

At this time, the swiveling covers 61 to 64 are mostly housed under the swiveling table 30 at the respective corners. Therefore, the four swiveling covers 61 to 64 protrude from the respective side surfaces of the swiveling table 30 only by small amounts. As depicted in FIG. 15, the four swiveling covers 61 to 64 are in contact with the side surfaces 31b and 31c (corresponding to the table stopper portion in the present invention) of the swiveling table main body 31 and are stopped, so that the amount by which each cover is housed under the swiveling table 30 is regulated.

In the above-described embodiment, the shape of the swiveling table main body 31 from the swiveling center 31a to the driven side end and the shape of the swiveling table main body 31 from the swiveling center 31a to the non-driven side end are formed like isosceles trapezoids. However, in any other embodiment, the shape of the widthwise edges of the swiveling table main body 31 may be curved rather than being linear.

In the above-described embodiment, the four swiveling covers 61 to 64 are supported so as to be able to swivel with respect to the fixing covers 32 and 33 for the swiveling table 30. However, in any other embodiment, the four swiveling covers 61 to 64 may be supported so as to be able to swivel with respect to the swiveling table main body 31. Furthermore, the four swiveling covers 61 to 64 may be supported so as to be able to swivel with respect to the traverse table 20.

Additionally, in the above-described embodiment, the four swiveling covers 61 to 64 are formed as separate members, and the swiveling centers 61a to 64a of the four swiveling covers 61 to 64 are set at different positions. In any other embodiment, the first swiveling cover 61 and the fourth swiveling cover 64 may be integrally formed. In addition, the second swiveling cover 62 and the third swiveling cover 63 may be integrally formed. In this case, the number of components is reduced.

Furthermore, in the embodiment of the present invention, the table traverse grinding machine has been taken as an example. However, the present invention is applicable to a wheel spindle stock traverse grinding machine. In the wheel spindle stock traverse grinding machine, the base in the present invention corresponds to a bed, and a swiveling table swivels on the bed. Furthermore, the present invention is applicable not only to the grinding machine but also to any other machine tool.

What is claimed is:

1. A machine tool with a swiveling table comprising:
a base that has four corners and is shaped to have a length larger than a width;
a swiveling table that is shaped to have a length larger than a width and that swivels while sliding on an upper surface of the base; and
a swiveling cover that is supported by the base or the swiveling table so as to be able to swivel, and protrudes from a widthwise edge of the swiveling table to cover a corner upper surface of the base in a first state where the swiveling table is not present on the corner upper surface of the base, and is housed under the swiveling table in a second state where the swiveling table is present on the corner upper surface of the base.

2. The machine tool with the swiveling table according to claim 1, wherein,
the base includes a base stopper portion, and
the swiveling cover includes a base regulating portion that stops in contact with the base stopper portion to keep protruding from the widthwise edge of the swiveling table.

3. The machine tool with the swiveling table according to claim 1, wherein,
the swiveling table includes a table stopper portion, and
the swiveling cover includes a table regulating portion that stops in contact with the table stopper portion to regulate an amount by which the swiveling cover is housed under the swiveling table.

4. The machine tool with the swiveling table according to claim 2, wherein,
the swiveling table includes a table stopper portion, and
the swiveling cover includes a table regulating portion that stops in contact with the table stopper portion to regulate an amount by which the swiveling cover is housed under the swiveling table.

5. The machine tool with the swiveling table according to claim 1, wherein,
the machine tool includes an elastic member that exerts a tensile force on the swiveling cover in a direction in which the swiveling cover is housed under the swiveling table, so as to reduce an amount by which the swiveling cover protrudes from the widthwise edge of the swiveling table in the second state.

6. The machine tool with the swiveling table according to claim 2, wherein,
the machine tool includes an elastic member that exerts a tensile force on the swiveling cover in a direction in which the swiveling cover is housed under the swiveling table, so as to reduce an amount by which the swiveling cover protrudes from the widthwise edge of the swiveling table in the second state.

7. The machine tool with the swiveling table according to claim 3, wherein,
the machine tool includes an elastic member that exerts a tensile force on the swiveling cover in a direction in which the swiveling cover is housed under the swiveling table, so as to reduce an amount by which the swiveling cover protrudes from the widthwise edge of the swiveling table in the second state.

8. The machine tool with the swiveling table according to claim 5, wherein,
the machine tool includes, as the swiveling cover, a first swiveling cover and a second swiveling cover that cover corner upper surfaces on respective widthwise opposite sides of the base, at a longitudinal first end of the swiveling table, and
the elastic member is attached to the first swiveling cover and to the second swiveling cover and exerts, in the second state, a tensile force in a direction in which the first swiveling cover and the second swiveling cover approach each other.

9. The machine tool with the swiveling table according to claim 1, wherein,
the machine tool includes four of the swiveling covers,
the swiveling covers cover respective four corners of the swiveling table, and
swiveling centers of the respective four swiveling covers are set at different positions.

10. The machine tool with the swiveling table according to claim 2, wherein,
the machine tool includes four of the swiveling covers,
the swiveling covers cover respective four corners of the swiveling table, and
swiveling centers of the respective four swiveling covers are set at different positions.

11. The machine tool with the swiveling table according to claim 3, wherein,
the machine tool includes four of the swiveling covers,
the swiveling covers cover respective four corners of the swiveling table, and
swiveling centers of the respective four swiveling covers are set at different positions.

12. The machine tool with the swiveling table according to claim 5, wherein,
the machine tool includes four of the swiveling covers,
the swiveling covers cover respective four corners of the swiveling table, and
swiveling centers of the respective four swiveling covers are set at different positions.

13. The machine tool with the swiveling table according to claim 8, wherein,
the machine tool includes four of the swiveling covers,
the swiveling covers cover respective four corners of the swiveling table, and
swiveling centers of the respective four swiveling covers are set at different positions.

14. The machine tool with the swiveling table according to claim 1, wherein,
the machine tool includes four of the swiveling covers,
the swiveling covers cover respective four corners of the swiveling table, and
two of the four swiveling covers that are diagonally positioned are integrally formed.

15. The machine tool with the swiveling table according to claim 2, wherein,
the machine tool includes four of the swiveling covers,
the swiveling covers cover respective four corners of the swiveling table, and
two of the four swiveling covers that are diagonally positioned are integrally formed.

16. The machine tool with the swiveling table according to claim 3, wherein,
the machine tool includes four of the swiveling covers,
the swiveling covers cover respective four corners of the swiveling table, and
two of the four swiveling covers that are diagonally positioned are integrally formed.

17. The machine tool with the swiveling table according to claim 5, wherein,
the machine tool includes four of the swiveling covers,
the swiveling covers cover respective four corners of the swiveling table, and
two of the four swiveling covers that are diagonally positioned are integrally formed.

18. The machine tool with the swiveling table according to claim 8, wherein,
the machine tool includes four of the swiveling covers,
the swiveling covers cover respective four corners of the swiveling table, and
two of the four swiveling covers that are diagonally positioned are integrally formed.
